(19) United States
(12) Patent Application Publication
(10) Pub. No.: US 2026/0212572 A1
(43) Pub. Date: Jul. 23, 2026

(54) ELECTROMAGNETIC TOMOGRAPHY WITHIN AIR-FILLED IMAGING CHAMBER

(71) Applicant: EMTensor GmbH, Vienna (AT)

(72) Inventor: Serguei SEMENOV, Vienna (AT)

(73) Assignee: EMTensor GmbH, Vienna (AT)

(21) Appl. No.: 19/445,500

(22) Filed: Jan. 10, 2026

Related U.S. Application Data
(63) Continuation of application No. PCT/US24/37482, filed on Jul. 10, 2024.
(60) Provisional application No. 63/628,295, filed on Jul. 10, 2023.

(51) Int. Cl. G06T 12/30; G01N 27/22; G06T 12/10

(52) U.S. Cl. CPC G06T 12/30; G01N 27/221; G06T 12/10

(57) ABSTRACT

A system for electromagnetic tomography within air-filled imaging chamber, thereby reconstructing 3D and/or 2D images ε(r)^{d}_{updated} of dielectric properties of an object under the study, includes an electromagnetic measurements system, an imaging chamber having an air-filled central cavity, computational means, an analog-to-digital converter (ADC) for digitizing acquired EM signals from the electromagnetic measurements system, and a processor system that executes imagining and processing algorithms. The imaging chamber includes a dielectric layer surrounding the air-filled central cavity, a ceramic antenna layer surrounding the dielectric layer, and an absorptive layer surrounding the ceramic antenna layer, wherein the ceramic antenna layer includes an array of antennas that form part of the electromagnetic measurement system.

### CROSS-REFERENCE TO RELATED APPLICATION

The present application is a U.S. continuation patent application of, and claims priority under 35 U.S.C. § 120 to, International Application No. PCT/US2024/037482, filed Jul. 10, 2024, designating the U.S., and entitled “ELECTROMAGNETIC TOMOGRAPHY WITHIN AIR-FILLED CHAMBER,” which '482 application published as WO 2025/015114 A2 on Jan. 16, 2025, which '482 application and the application publication thereof are each expressly incorporated herein by reference in their entirety, and which '482 application, for purposes of the United States, is a U.S. nonprovisional patent application of, and claims priority under 35 U.S.C. § 119(e) to, U.S. provisional patent application Ser. No. 63/628,295, filed Jul. 10, 2023, and entitled, “ELECTROMAGNETIC TOMOGRAPHY WITHIN AIR-FILLED IMAGING CHAMBER,” which '295 application is incorporated by reference herein in its entirety.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

### Field of the Present Invention

The following relates to a system and to a method for electromagnetic tomographic imaging of biological objects within air-filled imaging chamber/domain.

### Background

Within non-ionizing portion of electromagnetic spectrum biological objects are differentiated and consequentially can be imaged based on the differences in their dielectric properties. It is known that dielectric properties of tissues with high (such as muscle) and low (such as fat and bone) water content are significantly different. During the last decades the changes in dielectric properties of tissues caused by various physiological and pathological alterations, such as blood content, ischemia, infarction, hypoxia and malignancy have been intensively studied. In our pre-clinical studies, we've shown that dielectric properties of brain soft tissues and skeletal muscles tissues are sensitive to the blood content of tissues and dielectric properties of myocardium are sensitive to its blood content and hypoxia with almost immediate effect following intervention.

Electromagnetic tomography is a medical imaging technique which utilized an electromagnetic radiation from a non-ionizing portion of electromagnetic spectrum (for example a portion of the spectrum from 0.01 GHz to 10 GHz) for an interrogation of an object under the study. In this portion of electromagnetic spectrum tissues are imaged based on their dielectric properties. Therefore, within an electromagnetic tomography, a 3D image of a biological object is a 3D distribution of the dielectric properties of tissues within an imaging domain, obtained by so-called images reconstruction mathematical methods, specifically developed for such purposes.

With electromagnetic tomography (EMT), a biological object under the study (for example human head or human torso) is positioned inside of a so-called imaging domain or imaging chamber. In this regard, FIG. 1 is an XY-cross-sectional view of a prior art EMT imaging chamber 10. A chamber wall 16 includes antennas, typically metallic chamber wall with a plurality of antennas (sensors) located thereon. EMT of biological objects requires the use of a so-called matching media 12 of ε0 placed in-between antennas/sensors and a boundary of an object 14 (ex: a human head) to be imaged within the imaging chamber. There are reasons for it.
(1) The reflection coefficient of electromagnetic (EM) radiation on a boundary of two medias with different dielectric properties, for example air-to-muscle boundary at frequency near 1 GHz is about 0.75, meaning only about 25% of incident EM radiation will penetrate into a biological object. This is because of mismatch of dielectric property of air (ε′~1) and a typical soft tissue value of about ε′~40-50 at frequency near 1 GHz. To avoid such high reflection of interrogating EM radiation on the boundary of an object it is desirable to match dielectric properties of a media surrounding an object with dielectric properties of outer portion of an object under the study. In previous example, the best value of dielectric property of a matching media is the one closed to ε′~40-50.
(2) Biological tissues provides a high attenuation of interrogated EM signals at the spectrum of our interest 0.01 GHz to 10 GHz, because both absorption and inner reflection. Typical attenuation of EM radiation via adult head is about 80 dB at frequency near 1 GHz. Receivers of EM radiation are positioned around an object under the study. The mission of the receivers is to measure EM radiation passed through an object. However, if an object is surrounded by a low attenuation media, such as air, than a parasitic signal passed around an object will “shadow” an informative, but highly attenuated EM signal interrogated an objected under the study. Therefore, it is desirable to have a media around an object with high attenuation. As an example, the desirable dielectric properties of matching media for an imaging of adult head can be about ε~(40−50)+j(15−25).

The need for having a matching media within an imaging chamber is a limiting factor of EMT of biological objects delivering inconvenience to both patients and healthcare service personal. It also adds to higher weight and bulkiness of EMT apparatus and possible noise in measured EM fields caused by un-wanted air inclusions.

Improvements can be obtained by overcoming the need for having matching media and instead using a natural air surrounding the object under study.

### SUMMARY OF THE PRESENT INVENTION

Some exemplary embodiments of the present invention may overcome one or more of the above disadvantages and other disadvantages not described above, but the present invention is not required to overcome any particular disadvantage described above, and some exemplary embodiments of the present invention may not overcome any of the disadvantages described above.

The present invention includes many aspects and features. Moreover, while many aspects and features relate to, and are described in, the context of electromagnetic tomographic imaging of biological objects within an air-filled imaging chamber/domain, the present invention is not limited to use only in such contexts, as will become apparent from the following summaries and detailed descriptions of aspects, features, and one or more embodiments of the present invention.

Broadly defined, the present invention according to one aspect relates to a method for electromagnetic tomography within air-filled imaging chamber, thereby reconstructing 3D and/or 2D images ε(r)^{d}_{updated} of dielectric properties of an object under the study. The method includes: providing an imaging chamber having an air-filled central cavity, a dielectric layer surrounding the air-filled central cavity, a ceramic antenna layer surrounding the dielectric layer, and an absorptive layer surrounding the ceramic antenna layer, wherein the ceramic antenna layer includes an array of antennas that form part of an electromagnetic measurement system; positioning a biological object under study within the air-filled central cavity such that an air layer of less than approximately 3 cm is established between the biological object and the dielectric layer; setting-up and controlling measurements hardware of the electromagnetic measurement system; operating the electromagnetic measurement system to generate complex electromagnetic signals; receiving the complex electromagnetic signals after passing through the central cavity and the biological object; digitizing the received complex electromagnetic signals in an analog-to-digital converter (ADC); using raw data acquired from the electromagnetic measurements system, forming a matrix of complex EM fields (amplitude and phase) from N transceivers measured on M receivers (M*N matrix; M≤N)−Sij^{EXP}, i=1,N; j=1,M; calibrating and forming a M*N matrix of calibrated Sij^{EXP} experimental data; using an “initial guess” as an initial distribution of dielectric properties ε₁(r) at 1^{st} iteration; and applying an iterative process to reconstruct an image, including calculating of Electromagnetic (EM) fields distribution from N (i=1,N) transceivers within the study domain Eᵢ(εₖ(r)) and on M (j=1,M) receivers Sij^{THR} at k^{th} iteration (k=1,K), calculating Δ(ε(r)), updating the distribution of dielectric properties within the study domain at iteration k as ε(r)_{updated}=εₖ₋₁(r)+Δ(ε(r)), thereby producing an updated image, and assessing ε(r)_{updated} against predetermined decision making criteria, wherein (A) if ε(r)_{updated} satisfies the predetermined decision making criteria, then outputting the reconstructed image ε(r)_{updated}, and (B) if ε(r)_{updated} does not satisfy the predetermined decision making criteria, then providing the reconstructed image ε(r)_{updated} to a next iteration cycle.

In a feature of this aspect, the method further includes a step of setting up parameters and geometrical configuration for the electromagnetic measurement system, including a frequency or frequencies to be used, a data acquisition time per acquisition frame, a number of frames acquired, dielectric properties of media surrounding an object under the study within and imaging domain, a number and geometrical position of each transmitting antenna used, and a number and geometrical position of each receiving antenna used.

In another feature of this aspect, the parameters and geometrical configuration are set up to produce a “lenses” type “focusing” effect, avoiding a significant portion of a “parasitic” EM flow around the biological object and effectively allowing for an imaging of inner structure of the biological object within the air-filled imaging chamber.

In another feature of this aspect, the frequency of EM radiation used is within a frequency band from about 0.7 GHz to about 2.5 GHz.

In another feature of this aspect, the “initial guess” used as an initial distribution of dielectric properties ε₁(r) at 1^{st} iteration is a homogeneous distribution of dielectric properties ε₁(r)=ε₀, where ε₀ is a known dielectric properties of outside of the biological object, but inside of an imaging domain.

In another feature of this aspect, the step of calculating Δ(ε(r)) uses a gradient-type method in the form of Σ_{i,j}^{N,M}(Eᵢ*(εₖ(r))×Eⱼ(εₖ(r))×(Sij^{THR}−Sij^{EXP}).

In another feature of this aspect, the step of calculating Δ(ε(r)) uses a Newton-type method in the form of an inversion of the matrix Dij=(Eᵢ*(εₖ(r))×Eⱼ(εₖ(r)).

In another feature of this aspect, the predetermined decision making criteria is based on the satisfaction of the following at iteration k:

$${\sum }_{i , j}^{NM} \vert ( {Sij}^{THR \_ iter = k} - {Sij}^{EXP} ) \vert < β * {\sum }_{i , j}^{NM} \vert ( {Sij}^{THR \_ iter = 1} - {Sij}^{EXP} ) \vert$$

where |A| is a norm of complex A and β is a convergence accuracy parameter.

In another feature of this aspect, the convergence accuracy parameter is 0.95.

In another feature of this aspect, the method further includes a step of storing electromagnetic measurements data and reconstructed images ε(r)_{updated} in memory.

In another feature of this aspect, outputting the reconstructed image ε(r)_{updated} includes outputting the reconstructed image ε(r)_{updated} to end-users.

In another feature of this aspect, outputting the reconstructed image ε(r)_{updated} includes outputting the reconstructed image ε(r)_{updated} to further post-processing and analysis.

In another feature of this aspect, the method further includes outputting results from the further post-processing and analysis to end users and storing the results in memory.

In another feature of this aspect, the step of providing an imaging chamber includes providing an imaging chamber wherein the dielectric layer has a thickness of at least about ¼ of the wavelength (λ[cm]) of EM radiation in the biological object, the ceramic layer has a thickness of about 0.5 [cm], and the absorptive layer has a thickness that is at least about ¼ of the wavelength (λ[cm]) of EM radiation in the biological object.

In another feature of this aspect, the wavelength (λ[cm]) of the EM radiation is about 4.7 [cm].

In another feature of this aspect, the step of providing an imaging chamber includes providing an imaging chamber wherein the dielectric layer has dielectric properties in the range of about 40(+/−30%)+j16(+/−30%), the ceramic layer has dielectric properties in the range of about 40(+/−30%)+j0.1(+/−30%), and the absorptive layer has dielectric properties in the range of about 40(+/−30%)+j40(−10% to + any).

In another feature of this aspect, the step of providing an imaging chamber includes providing an imaging chamber wherein the radiation pattern of each of the antennas is a modified point source described by

$$exp ( ikr ) / r \times {cos}^{2} ( ϕ ) \times cos ( θ )$$

where: r—radius-vector in 3D space; k—wave number; φ—azimuthal angle to a normal to antenna in XY-cross-section and θ—angle between radius-vector and XY-cross-section.

Broadly defined, the present invention according to another aspect related to a system for electromagnetic tomography within air-filled imaging chamber, thereby reconstructing 3D and/or 2D images ε(r)^{d}_{updated} of dielectric properties of an object under the study. The system includes: an electromagnetic measurements system; an imaging chamber having an air-filled central cavity, a dielectric layer surrounding the air-filled central cavity, a ceramic antenna layer surrounding the dielectric layer, and an absorptive layer surrounding the ceramic antenna layer, wherein the ceramic antenna layer includes an array of antennas that form part of the electromagnetic measurement system; computational means, including a processor, memory storage, RAM, an I/O interface, and a network adapter; an analog-to-digital converter (ADC) for digitizing acquired EM signals from the electromagnetic measurements system; and a processor system that executes imagining and processing algorithms. After a biological object under study is positioned within the air-filled central cavity such that an air layer of less than approximately 3 cm is established between the biological object and the dielectric layer, the system facilitates the steps of: setting-up and controlling measurements hardware of the electromagnetic measurement system; operating the electromagnetic measurement system to generate complex electromagnetic signals; receiving the complex electromagnetic signals after passing through the central cavity and the biological object; digitizing the received complex electromagnetic signals in an analog-to-digital converter (ADC); using raw data acquired from the electromagnetic measurements system, forming a matrix of complex EM fields (amplitude and phase) from N transceivers measured on M receivers (M*N matrix; M≤N)−Sij^{EXP}, i=1,N; j=1,M; calibrating and forming a M*N matrix of calibrated Sij^{EXP} experimental data; using an “initial guess” as an initial distribution of dielectric properties ε₁(r) at 1^{st} iteration; and applying an iterative process to reconstruct an image, including (A) calculating of Electromagnetic (EM) fields distribution from N (i=1,N) transceivers within the study domain Eᵢ(εₖ(r)) and on M (j=1,M) receivers Sij^{THR} at k^{th} iteration (k=1,K), (B) calculating Δ(ε(r)), (C) updating the distribution of dielectric properties within the study domain at iteration k as ε(r)_{updated}=εₖ₋₁(r)+Δ(ε(r)), thereby producing an updated image, and (D) assessing ε(r)_{updated} against predetermined decision making criteria, wherein (1) if ε(r)_{updated} satisfies the predetermined decision making criteria, then outputting the reconstructed image ε(r)_{updated}, and (2) if ε(r)_{updated} does not satisfy the predetermined decision making criteria, then providing the reconstructed image ε(r)_{updated} to a next iteration cycle.

In a feature of this aspect, the system further facilitates a step of setting up parameters and geometrical configuration for the electromagnetic measurement system, including a frequency or frequencies to be used, a data acquisition time per acquisition frame, a number of frames acquired, dielectric properties of media surrounding an object under the study within and imaging domain, a number and geometrical position of each transmitting antenna used, and a number and geometrical position of each receiving antenna used.

In another feature of this aspect, the parameters and geometrical configuration are set up to produce a “lenses” type “focusing” effect, avoiding a significant portion of a “parasitic” EM flow around the biological object and effectively allowing for an imaging of inner structure of the biological object within the air-filled imaging chamber.

In another feature of this aspect, the frequency of EM radiation used is within a frequency band from about 0.7 GHz to about 2.5 GHz.

In another feature of this aspect, the “initial guess” used as an initial distribution of dielectric properties ε₁(r) at 1^{st} iteration is a homogeneous distribution of dielectric properties ε₁(r)=ε₀, where ε₀ is a known dielectric properties of outside of the biological object, but inside of an imaging domain.

In another feature of this aspect, the step of calculating Δ(ε(r)) uses a gradient-type method in the form of Σ_{i,j}^{N,M}(Eᵢ*(εₖ(r))×Eⱼ(εₖ(r))×(Sij^{THR}−Sij^{EXP}).

In another feature of this aspect, the step of calculating Δ(ε(r)) uses a Newton-type method in the form of an inversion of the matrix Dij=(Eᵢ*(εₖ(r))×Eⱼ(εₖ(r)).

In another feature of this aspect, the predetermined decision making criteria is based on the satisfaction of the following at iteration k:

$${\sum }_{i , j}^{NM} \vert ( {Sij}^{THR \_ iter = k} - {Sij}^{EXP} ) \vert < β * {\sum }_{i , j}^{NM} \vert ( {Sij}^{THR \_ iter = 1} - {Sij}^{EXP} ) \vert$$

where |A| is a norm of complex A and β is a convergence accuracy parameter.

In another feature of this aspect, the convergence accuracy parameter is 0.95.

In another feature of this aspect, a further step is facilitated of storing electromagnetic measurements data and reconstructed images ε(r)_{updated} in memory.

In another feature of this aspect, outputting the reconstructed image ε(r)_{updated} includes outputting the reconstructed image ε(r)_{updated} to end-users.

In another feature of this aspect, outputting the reconstructed image ε(r)_{updated} includes outputting the reconstructed image ε(r)_{updated} to further post-processing and analysis.

In another feature of this aspect, a further step is facilitated of outputting results from the further post-processing and analysis to end users and storing the results in memory.

In another feature of this aspect, the dielectric layer has a thickness of at least about ¼ of the wavelength (λ[cm]) of EM radiation in the biological object, the ceramic layer has a thickness of about 0.5 [cm], and the absorptive layer has a thickness that is at least about 14 of the wavelength (λ[cm]) of EM radiation in the biological object.

In another feature of this aspect, the wavelength (λ[cm]) of the EM radiation is about 4.7 [cm].

In another feature of this aspect, the dielectric layer has dielectric properties in the range of about 40(+/−30%)+j16(+/−30%), the ceramic layer has dielectric properties in the range of about 40(+/−30%)+j0.1(+/−30%), and the absorptive layer has dielectric properties in the range of about 40(+/−30%)+j40(−10% to + any).

In another feature of this aspect, the radiation pattern of each of the antennas is a modified point source described by

$$exp ( ikr ) / r \times {cos}^{2} ( ϕ ) \times cos ( θ )$$

where: r—radius-vector in 3D space; k—wave number; φ—azimuthal angle to a normal to antenna in XY-cross-section and θ—angle between radius-vector and XY-cross-section.

According to one or more aspects, the present invention comprises a novel system and method for Electromagnetic Tomography (EMT) of biological objects with air-filled imaging chamber using a specially constructed multi-layered wall of the chamber together with the use of certain frequency band of an interrogating EM radiation certain antenna' radiation/reception pattern.

Further areas of applicability of the present invention will become apparent from the detailed description provided hereinafter. It should be understood that the detailed description and specific examples, while indicating preferred embodiment(s) of the invention, are intended for purposes of illustration only and are not intended to limit the scope of the invention.

### BRIEF DESCRIPTION OF THE DRAWINGS

Aspects of the present disclosure may take form in various components and arrangements of components, and in various steps and arrangements of steps. The drawings are only for illustration purpose of preferred embodiments of the present disclosure and are not to be considered as limiting.

Features of embodiments of the present disclosure will be more readily understood from the following detailed description taken in conjunction with the accompanying drawings in which:

FIG. 1 is an XY-cross-sectional view of a prior art EMT imaging chamber;

FIG. 2 is an XY-cross-sectional view of a specifically developed air-filled EMT imaging chamber in accordance with one or more preferred embodiments of the present invention;

FIG. 3 is a graphical representation of an electromagnetic field distribution within a prior art EMT imaging chamber;

FIG. 4 is a graphical representation of an electromagnetic field distribution within a specifically developed air-filled EMT imaging chamber;

FIG. 5 is a graphical representation of a dielectric distribution for the specially developed air-filled imaging chamber and object of the study, shown in XY cross-section, of FIG. 2;

FIG. 6 is a graphical representation of one of the successive reconstructed images (real part) of the object (virtual model of human head) presented in FIG. 5;

FIGS. 7 and 8 are block diagrams of an electromagnetic tomography system using an air-filled chamber in accordance with one or more preferred embodiments of the present invention; and

FIG. 9 is a flow diagram illustrating a method for electromagnetic tomography within an air-filled imaging chamber in accordance with one or more preferred embodiments of the present invention.

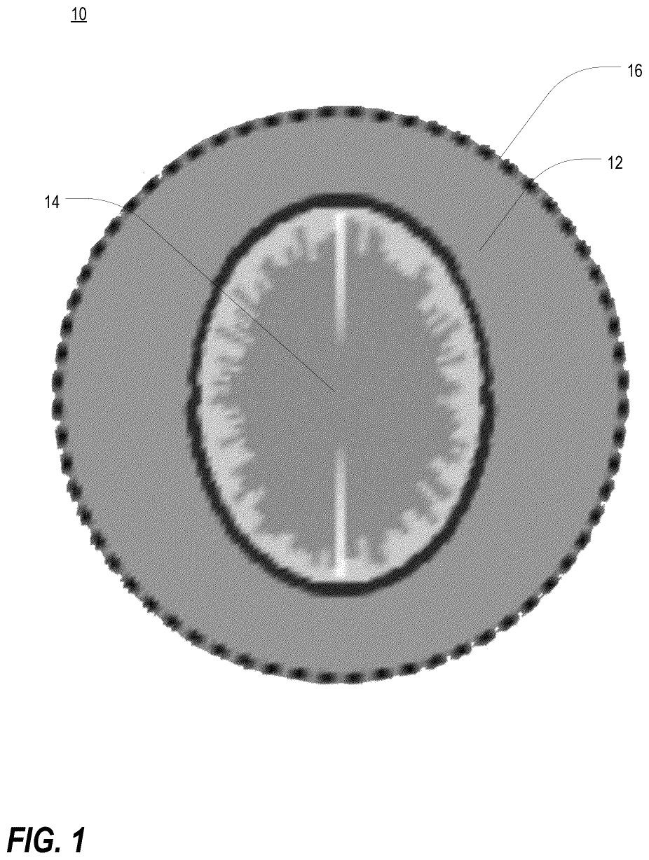

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Furthermore, an embodiment of the invention may incorporate only one or a plurality of the aspects of the invention disclosed herein; only one or a plurality of the features disclosed herein; or combination thereof. Moreover, many embodiments, including adaptations, variations, modifications, and equivalent arrangements, are implicitly disclosed herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention in any claim of a patent issuing here from, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once during performance of the claimed method.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Further, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiment(s) is merely exemplary in nature and is in no way intended to limit the invention, its application, or uses.

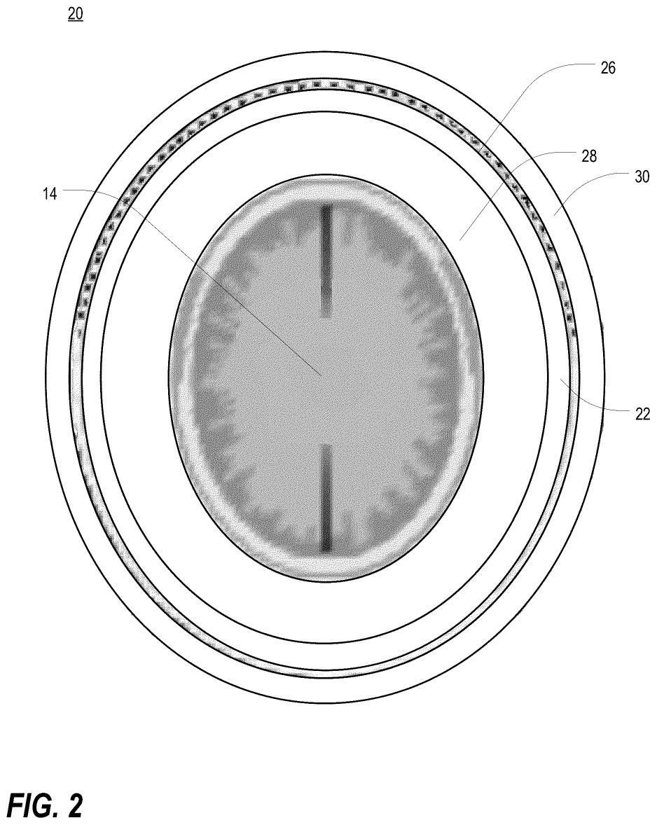

FIG. 2 is an XY-cross-sectional view of a specifically developed air-filled EMT imaging chamber 20 in accordance with one or more preferred embodiments of the present invention. In FIG. 2, an object under study 14 (ex: a human head) is shown arranged inside the chamber. A chamber wall comprises a ceramic layer 26 with embedded ceramic antennas (only a portion of antennas shown). Also shown are a dielectric layer 22, an air layer 28, and an absorptive layer 30. The radial dimensions (thicknesses) of the various layers used in the chamber 20 may vary, but are preferably selected based on the wavelength (λ[cm]) of EM radiation in an object under the study (in a human head example used here λ~4.7 [cm]). The dielectric layer 22 preferably has a thickness of at least about 1% of the wavelength (λ[cm]) of EM radiation in the object under the study 14, the ceramic layer 26 preferably has a thickness of about 0.5 [cm], and the absorptive layer 30 preferably has a thickness that is at least about ¼ of the wavelength (λ[cm]) of EM radiation in the object under the study 14.

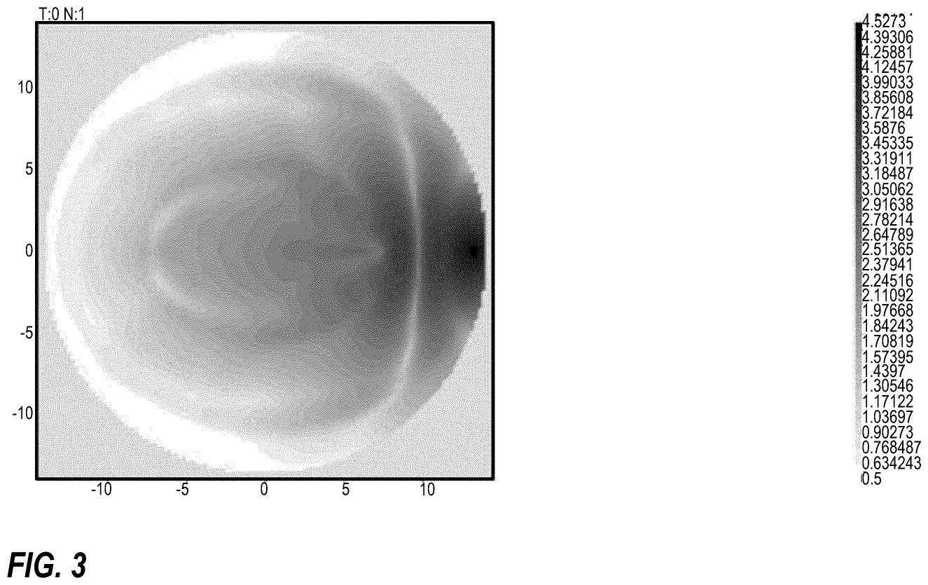

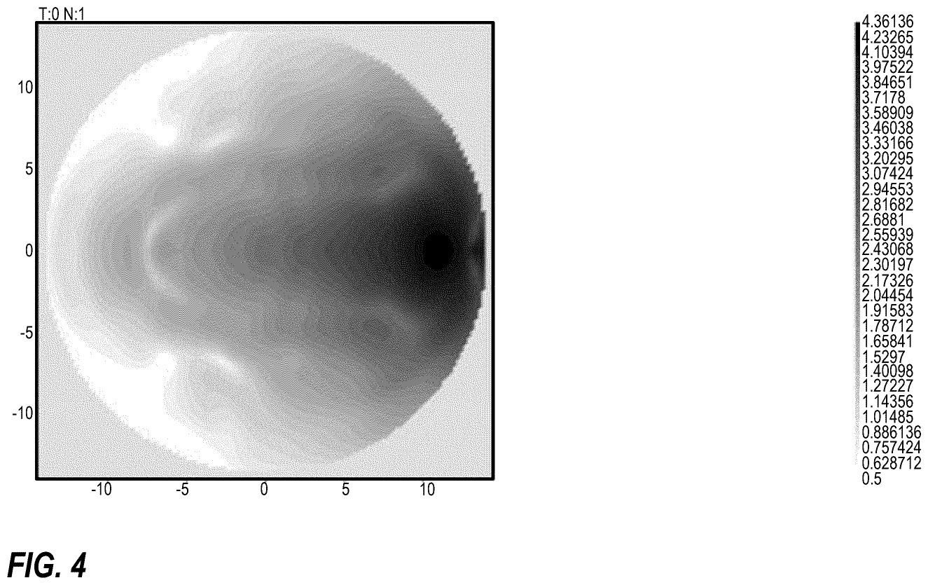

Differences between the results obtained from a prior art imaging chamber 10 versus an imaging chamber 20 of the present invention are seen by comparing FIGS. 3 and 4. FIG. 3 is a graphical representation of an electromagnetic field distribution within a prior art EMT imaging chamber 10 with matching media of ε0 and a virtual model of a human head 14 from transmitting antenna no. 1, located at right-mid site of the imaging domain at the point X=14, Y=0 [cm]. The amplitude of EM field is shown in XY cross-section. In this example, the radiation pattern of antennas is a modified point source described by: exp(ikr)/r×cos²(φ)×cos(θ), where: r—radius-vector in 3D space; k—wave number; φ—azimuthal angle to a normal to antenna in XY-cross-section and θ—angle between radius-vector and XY-cross-section.

FIG. 4, by comparison, is a graphical representation of an electromagnetic field distribution within a specifically developed air-filled EMT imaging chamber 20 and a virtual model of a human head 14 from transmitting antenna no. 1, located at the same location as in FIG. 3 above at right-mid site of the imaging domain at the point X=14, Y=0 [cm]. Again, the amplitude of EM field is shown in XY cross-section. A combination of the geometry of the chamber, frequency of EM radiation used (in this case Freq=1.25 GHz) with a multilayered wall construction as described herein produce a “lenses” type, “focusing” effect, avoiding a significant portion of a “parasitic” EM flow around an object under the study, effectively allowing for an imaging of inner structure of an object. In this example, the radiation pattern of antennas is a modified point source described by: exp(ikr)/r×cos²(φ)×cos(θ), where: r—radius-vector in 3D space; k—wave number; φ—azimuthal angle to a normal to antenna in XY-cross-section and θ—angle between radius-vector and XY-cross-section.

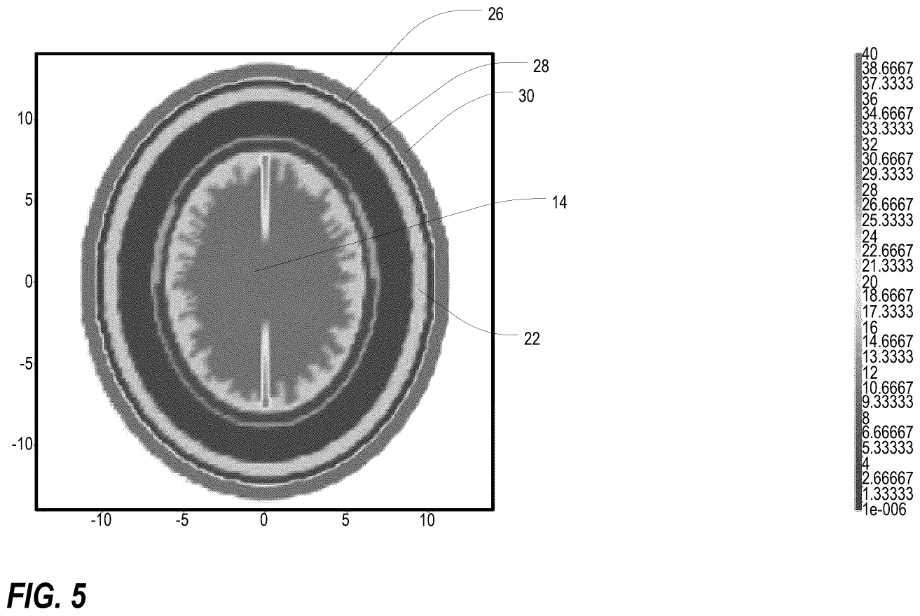

FIG. 5 is a graphical representation of a dielectric distribution for the specially developed air-filled imaging chamber 20 and object of the study 14, shown in XY cross-section, of FIG. 2. The air layer 28 in this example is approximately 2 cm thick, but may vary, with a maximum thickness of approximately 3 cm. The dielectric layer 22 uses dielectric properties of 40+j16 is used. The ceramic layer 26 utilizes embedded ceramic antennas (not shown in FIG. 5).

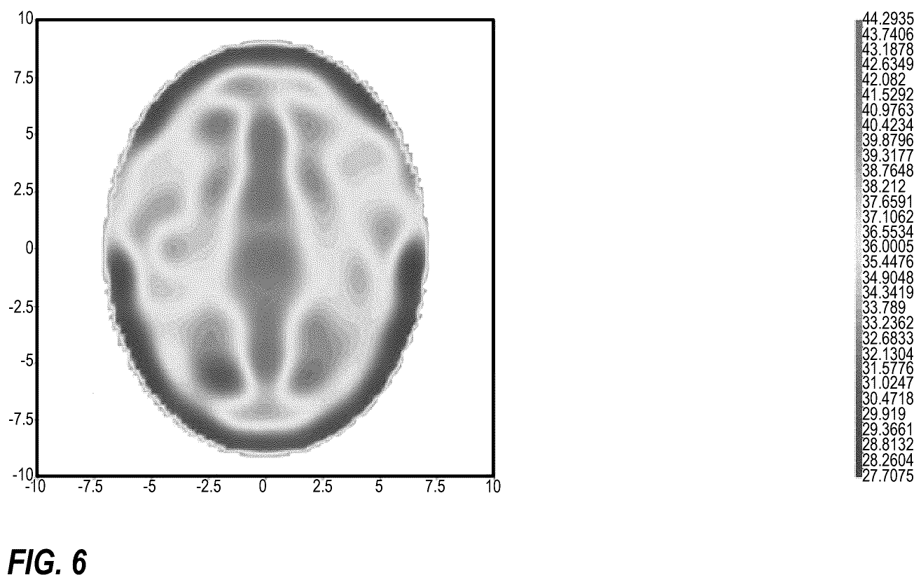

FIG. 6 is a graphical representation of one of the successive reconstructed images (real part) of the object (virtual model of human head) presented in FIG. 5. This is the case when frequency 1.25 GHz is used and dielectric properties of corresponding layers were 40+j16 for the dielectric layer 22, 40+j0.1 for the ceramic layer 26, and 40+j40 for the absorptive layer 30. However, it will be appreciated that the EM radiation frequency may vary, with the specific frequency used preferably being within a frequency band from about 0.7 GHz to about 2.5 GHz. Also, it will be appreciated that in various embodiments, dielectric properties of the layers of the wall of the air-filled imaging chamber may vary, with the dielectric layer 22 varying in the range of about 40(+/−30%)+j16(+/−30%); the ceramic layer 26 varying in the range of about 40(+/−30%)+j0.1(+/−30%), and the absorptive layer 30 varying in the range of about 40(+/−30%)+j40(−10% to + any).

In the example of FIG. 6, 5% random noise was added to the raw Sij data, and a gradient images reconstruction method of electromagnetic tomography was used. As described herein, the reconstruction process may be iterated as desired; the particular image shown in FIG. 5 was iteration no. 100, and the convergence=99.64%. In this example, the radiation pattern of the antennas is a modified point source described by: exp(ikr)/r×cos²(φ)×cos(θ), where: r—radius-vector in 3D space; k—wave number; φ—azimuthal angle to a normal to antenna in XY-cross-section and θ—angle between radius-vector and XY-cross-section.

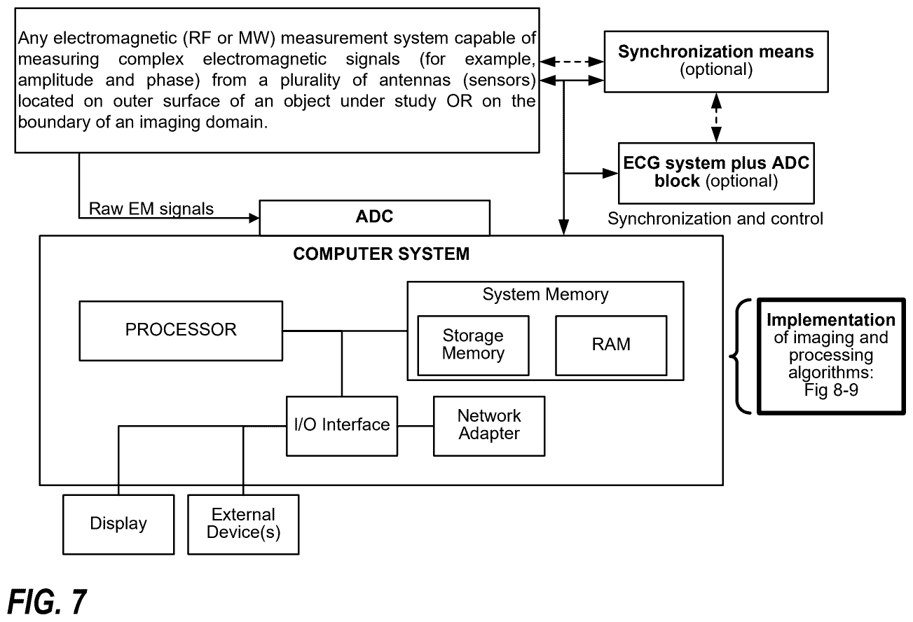

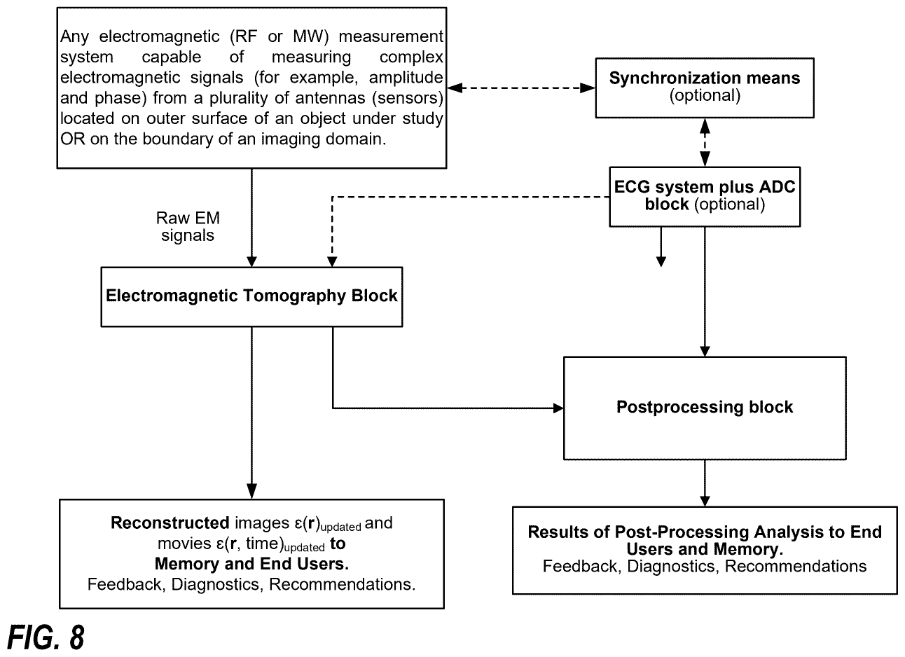

FIGS. 7 and 8 are block diagrams of an electromagnetic tomography system using an air-filled chamber in accordance with one or more preferred embodiments of the present invention. As shown therein, the system includes an electromagnetic (for example RF or MW) measurement system, an analog-to-digital converter (ADC), a processor system, a computer system or other computational means, an image reconstruction system, and a post-processing system. The electromagnetic (RF or MW) measurement system receives complex electromagnetic signals (for example amplitude and phase). The particular system is not critical, so long as it is capable of measuring complex electromagnetic signals from a plurality of antennas (sensors) located on the outer surface of an object under study or on the boundary of an imaging domain. The analog-to-digital converter (ADC) digitizes acquired EM signals from electromagnetic (for example, but not limited to, RF or MW) measurements system. The computer system or other computational means preferable includes a processor, memory storage, RAM, I/O interface, network adapter, and the like. The processor system executes imagining and processing algorithms via software executable modules, firmware, an ASIC-based implementation, or the like according to one or methods of the present invention. The image reconstruction system receives complex electromagnetic signals (for example, amplitude and phase) from the electromagnetic measurement system and provides a reconstruction of 3D and/or 2D images ε(r)_{updated} of dielectric properties of an object under the study. The post-processing system provides post-processing of reconstructed dielectric images and/or movies. The reconstructed dielectric images and/or movies are delivered to end-users and/or memory storage and are also analyzed via the post-processing system, with the results of the latter also being delivered to end-users and/or memory storage.

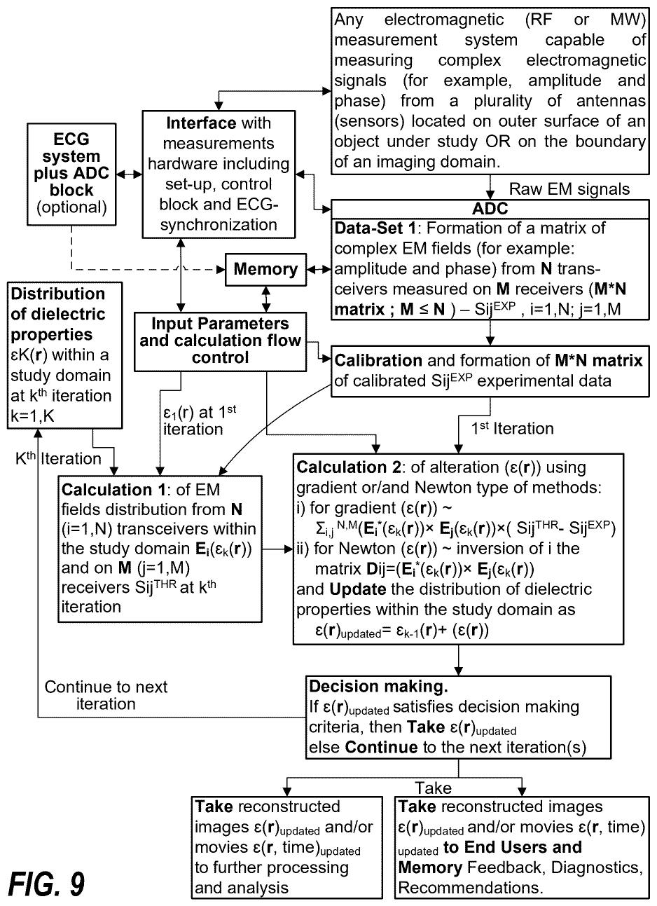

FIG. 9 is a flow diagram illustrating a method for electromagnetic tomography within an air-filled imaging chamber in accordance with one or more preferred embodiments of the present invention. As illustrated therein, complex electromagnetic signals (for example amplitude and phase) are received from an electromagnetic (for example RF or microwave) measurement system. The particular system is not critical, so long as it is capable of measuring complex electromagnetic signals from a plurality of antennas (sensors) located on the outer surface of an object under study or on the boundary of an imaging domain. Parameters and geometrical configurations for the electromagnetic measurement system may include, for example, the frequency or frequencies to be used, data acquisition time per acquisition frame, number of frames acquired, dielectric properties of media surrounding an object under the study within and imaging domain, number and geometrical position (for example, but not limited to (x,y,z) in Cartesian coordinate system) of each transmitting antenna used, and the number and geometrical position (for example, but not limited to (x,y,z) in Cartesian coordinate system) of each receiving antenna used.

The received complex electromagnetic signals are digitized in an analog-to-digital converter (ADC) that may be located in the receivers. The measurement hardware of the electromagnetic (RF or microwave) measurement system is set up and controlled. Using raw data acquired from the electromagnetic measurements system, a matrix is formed of complex EM fields (for example: amplitude and phase) from N transceivers measured on M receivers (M*N matrix; M≤N)−Sij^{EXP}, i=1,N; j=1,M. The M*N matrix of calibrated Sij^{EXP} experimental data is calibrated and formed. In addition, input and control parameters and calculation flow control are set up.

With the foregoing in place, an iterative method may then be applied to reconstruct an image. An “initial guess” is used as an initial distribution of dielectric properties ε₁(r) at 1^{st} iteration (for example, but not limited to, a homogeneous distribution of dielectric properties ε₁(r)=ε₀, where ε₀ is, for example, but not limited to, a known dielectric properties of outside of an object under the study, but inside of an imaging domain). An electromagnetic (EM) fields distribution is calculated from N (i=1,N) transceivers within the study domain Eᵢ(εₖ(r)) and on M (j=1,M) receivers Sij^{THR} at k^{th} iteration (k=1,K). Δ(ε(r)) may be calculated using gradient or/and Newton type of methods, where for gradient Δ(ε(r))~E_{i,j}^{N,M}(Eᵢ*(εₖ(r))×Eⱼ(εₖ(r))×(Sij^{THR}−Sij^{EXP}), and for Newton Δ(ε(r))~inversion of the matrix Dij=(Eᵢ*(εₖ(r))×Eⱼ(εₖ(r)). The distribution of dielectric properties within the study domain is updated at iteration k as ε(r)_{updated}=εₖ₋₁(r)+Δ(ε(r)), thereby producing an updated image. At this point, a decision is made, wherein the decision making may be based on the satisfaction of the following (for example, but not limited to) at iteration k: Σ_{i,j}^{N,M}|(Sij^{THR_iter=k}−Sij^{EXP})|<β*Σ_{i,j}^{N,M}|(Sij^{THR_iter=1}−Sij^{EXP})|, where |A| is a norm of complex A and β is a convergence accuracy parameter, for example, but not limited to 0.95. If ε(r)_{updated} satisfies the decision making criteria, then the reconstructed image ε(r)_{updated} is provided (taken) to either end-users or to further post-processing and analysis (and the reconstructed image is stored in memory), whereas if ε(r)_{updated} does not satisfy decision making criteria, then the reconstructed image ε(r)_{updated} is input to the next iteration cycle as illustrated in FIG. 9. Finally, the electromagnetic measurements data and reconstructed images ε(r)_{updated} are stored in memory.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claim(s) appended hereto and the equivalents thereof.

1: A method for electromagnetic tomography within an air-filled imaging chamber, thereby reconstructing 3D and/or 2D images ε(r)^{d}_{updated} of dielectric properties of an object under the study, comprising:
(a) providing an imaging chamber having an air-filled central cavity, a dielectric layer surrounding the air-filled central cavity, a ceramic antenna layer surrounding the dielectric layer, and an absorptive layer surrounding the ceramic antenna layer, wherein the ceramic antenna layer includes an array of antennas that form part of an electromagnetic measurement system;
(b) positioning a biological object under study within the air-filled central cavity such that an air layer of less than approximately 3 cm is established between the biological object and the dielectric layer;
(c) operating the electromagnetic measurement system to generate complex electromagnetic signals transmitted via transmitting antennas;
(d) receiving the complex electromagnetic signals at receiving antennas after passing through the central cavity and the biological object;
(e) digitizing the received complex electromagnetic signals in an analog-to-digital converter (ADC);
(f) using raw data acquired from the electromagnetic measurements system, forming a matrix of complex EM fields (amplitude and phase) from N transceivers measured on M receivers (M*N matrix; M≤N)−Sij^{EXP}, i=1,N; j=1,M;
(g) calibrating and forming a M*N matrix of calibrated Sij^{EXP} experimental data;
(h) using an “initial guess” as an initial distribution of dielectric properties ε₁(r) at a 1^{st} iteration,
applying an iterative process to reconstruct an image, the iterative process including:
(i) calculating of Electromagnetic (EM) fields distribution from N (i=1,N) transceivers within a study domain Eᵢ(εₖ(r)) and on M (j=1,M) receivers Sij^{THR} at k^{th} iteration (k=1,K),
(ii) calculating Δ(ε(r)),
(iii) updating the distribution of dielectric properties within the study domain at iteration k as ε(r)_{updated}=εₖ₋₁(r)+Δ(ε(r)), thereby producing an updated image, and
(iv) assessing ε(r)_{updated} against predetermined decision making criteria, wherein:
(A) if ε(r)_{updated} satisfies the predetermined decision making criteria, then outputting the reconstructed image ε(r)_{updated}, and
(B) if ε(r)_{updated} does not satisfy the predetermined decision making criteria, then providing the reconstructed image ε(r)_{updated} to a next iteration cycle.

2: The method of claim 1, further comprising a step of setting up parameters and geometrical configuration for the electromagnetic measurement system, including a frequency or frequencies to be used, a data acquisition time per acquisition frame, a number of frames acquired, dielectric properties of media surrounding the object under the study within the imaging chamber, a number and geometrical position of each transmitting antenna used, and a number and geometrical position of each receiving antenna used.

3: The method of claim 2, wherein the parameters and geometrical configuration are set up to produce a “lenses” type “focusing” effect, avoiding a significant portion of a “parasitic” EM flow around the biological object and effectively allowing for an imaging of inner structure of the biological object within the air-filled imaging chamber.

4: The method of claim 1, wherein the frequency of EM radiation used is within a frequency band from about 0.7 GHz to about 2.5 GHz.

5: The method of claim 1, wherein the “initial guess” used as an initial distribution of dielectric properties ε₁(r) at 1^{st} iteration is a homogeneous distribution of dielectric properties ε₁(r)=ε₀, where ε₀ is a known dielectric properties of a region outside of the biological object, but inside of the imaging chamber.

6: The method of claim 1, wherein the step of calculating Δ(ε(r)) uses a gradient-type method in the form of Σ_{i,j}^{N,M}(Eᵢ*(εₖ(r))×Eⱼ(εₖ(r))×(Sij^{THR}−Sij^{EXP})).

7: The method of claim 1, wherein the step of calculating Δ(ε(r)) uses a Newton-type method in the form of an inversion of the matrix Dij=(Eᵢ*(εₖ(r))×Eⱼ(εₖ(r))).

8: The method of claim 1, wherein the predetermined decision making criteria is based on the satisfaction of the following at iteration k:
$${\sum }_{i , j}^{NM} \vert ( {Sij}^{THR \_ iter = k} - {Sij}^{EXP} ) \vert < β * {\sum }_{i , j}^{NM} \vert ( {Sij}^{THR \_ iter = 1} - {Sij}^{EXP} ) \vert$$
where |A| is a norm of complex A and β is a convergence accuracy parameter.

9: The method of claim 8, wherein the convergence accuracy parameter is 0.95.

10: The method of claim 1, further comprising a step of storing electromagnetic measurements data and reconstructed images ε(r)_{updated} in memory.

11: The method of claim 1, wherein outputting the reconstructed image ε(r)_{updated} includes outputting the reconstructed image ε(r)_{updated} to end-users.

12: The method of claim 1, wherein outputting the reconstructed image ε(r)_{updated} includes outputting the reconstructed image ε(r)_{updated} to further post-processing and analysis.

13: The method of claim 12, further comprising outputting results from the further post-processing and analysis to end users and storing the results in memory.

14: The method of claim 1, wherein the step of providing an imaging chamber includes providing an imaging chamber wherein the dielectric layer has a thickness of at least about ¼ of the wavelength (λ[cm]) of EM radiation in the biological object, the ceramic layer has a thickness of about 0.5 [cm], and the absorptive layer has a thickness that is at least about ¼ of the wavelength (λ[cm]) of EM radiation in the biological object.

15: The method of claim 14, wherein the wavelength (λ[cm]) of the EM radiation is about 4.7 [cm].

16: The method of claim 1, wherein the step of providing an imaging chamber includes providing an imaging chamber wherein the dielectric layer has dielectric properties in the range of about 40(+/−30%)+j16(+/−30%), the ceramic layer has dielectric properties in the range of about 40(+/−30%)+j0.1(+/−30%), and the absorptive layer has dielectric properties in the range of about 40(+/−30%)+j40(−10% to + any).

17: The method of claim 1, wherein the step of providing an imaging chamber includes providing an imaging chamber wherein the radiation pattern of each of the antennas is a modified point source described by
$$exp ( ikr ) / r \times {cos}^{2} ( ϕ ) \times cos ( θ )$$
where: r—radius-vector in 3D space; k—wave number; φ—azimuthal angle to a normal to antenna in XY-cross-section and θ—angle between radius-vector and XY-cross-section.

18-34. (canceled)
